(19) United States
(12) Patent Application Publication
(10) Pub. No.: US 2022/0237632 A1
(43) Pub. Date: Jul. 28, 2022

(54) OPPORTUNITY CONVERSION RATE CALCULATOR

(71) Applicant: EMC IP Holding Company LLC, Hopkinton, MA (US)

(72) Inventors: Anat Parush Tzur, Be'er Sheva (IL); Amihai Savir, Sansana (IL)

(73) Assignee: EMC IP Holding Company LLC, Hopkinton, MA (US)

(21) Appl. No.: 17/155,476

(22) Filed: Jan. 22, 2021

(51) Int. Cl. G06Q 30/02; G06F 40/30; G06F 40/279; G06K 9/62

(52) U.S. Cl. CPC G06Q 30/0201; G06F 40/30; G06K 9/6276; G06K 9/6232; G06K 9/6215; G06F 40/279

(57) ABSTRACT

A method comprising: retrieving one or more customer engagement records, the one or more customer engagement records being associated with an opportunity for making a sale to a customer; identifying a plurality of free text samples that are part of the customer engagement records; identifying a plurality of data items that are part of the free text samples; calculating a plurality of semantic distances, each of the semantic distances corresponding to a different one of a plurality of data item pairs; clustering the data items into textual clusters based on the identified semantic distances; and training a classifier based, at least in part, on the textual clusters, the classifier being configured to receive an offer for the customer, classify the offer and output an estimation of whether the offer is expected to result in a sale.

### BACKGROUND

Companies often have to bid on private and public contracts as part of their business model. Bidding on public and private contracts is a complex process, and it is often difficult to predict whether a particular offer will be accepted. For this reason, companies occasionally employ conversion calculators that utilize machine learning to predict whether a particular offer will result in a sale.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

According to aspects of the disclosure, a method is provided comprising: retrieving one or more customer engagement records, the one or more customer engagement records being associated with an opportunity for making a sale to a customer; identifying a plurality of free text samples that are part of the customer engagement records; identifying a plurality of data items that are part of the free text samples; calculating a plurality of semantic distances, each of the semantic distances corresponding to a different one of a plurality of data item pairs; clustering the data items into textual clusters based on the identified semantic distances; and training a classifier based, at least in part, on the textual clusters, the classifier being configured to receive an offer for the customer, classify the offer and output an estimation of whether the offer is expected to result in a sale.

According to aspects of the disclosure, a system is provided, comprising: a memory; and at least one processor that is operatively coupled to the memory, the at least one processor being configured to perform the operations of: retrieving one or more customer engagement records, the one or more customer engagement records being associated with an opportunity for making a sale to a customer; identifying a plurality of free text samples that are part of the customer engagement records; identifying a plurality of data items that are part of the free text samples; calculating a plurality of semantic distances, each of the semantic distances corresponding to a different one of a plurality of data item pairs; clustering the data items into textual clusters based on the identified semantic distances; and training a classifier based, at least in part, on the textual clusters, the classifier being configured to receive an offer for the customer, classify the offer and output an estimation of whether the offer is expected to result in a sale.

According to aspects of the disclosure, a non-transitory computer-readable storage medium is provided that is configured to store one or more processor executable instructions, which, when executed by one or more processors, cause the one or more processors to perform the operations of: retrieving one or more customer engagement records, the one or more customer engagement records being associated with an opportunity for making a sale to a customer; identifying a plurality of free text samples that are part of the customer engagement records; identifying a plurality of data items that are part of the free text samples; calculating a plurality of semantic distances, each of the semantic distances corresponding to a different one of a plurality of data item pairs; clustering the data items into textual clusters based on the identified semantic distances; and training a classifier based, at least in part, on the textual clusters, the classifier being configured to receive an offer for the customer, classify the offer and output an estimation of whether the offer is expected to result in a sale.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a computing system, according to aspects of the disclosure;

FIG. 1B is a diagram of an example of a free text sample, according to aspects of the disclosure;

FIG. 2A is a flowchart of an example of a process, according to aspects of the disclosure;

FIG. 2B is a flowchart of an example of a process, according to aspects of the disclosure;

FIG. 3 is a flowchart of an example of a process, according to aspects of the disclosure;

FIG. 4 is a flowchart of an example of a process, according to aspects of the disclosure;

FIG. 5 is plot of the respective SHAP scores of training features that are used to train an opportunity classifier, according to aspects of the disclosure; and

### DETAILED DESCRIPTION

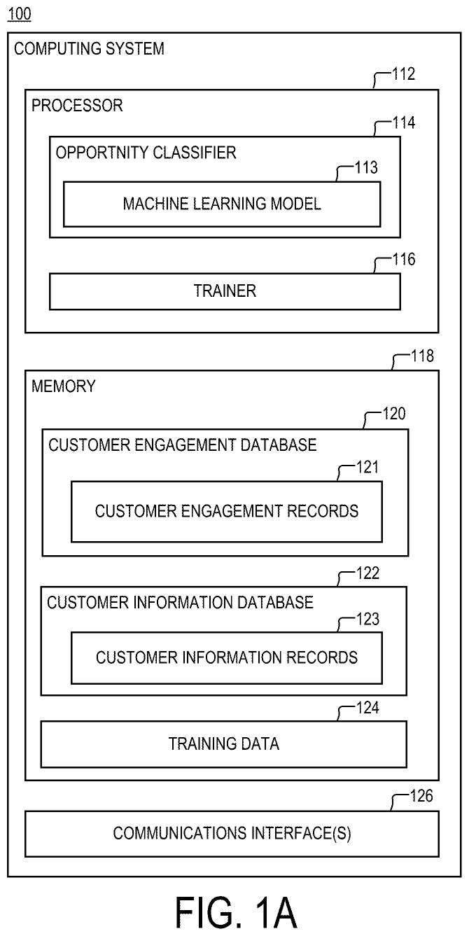

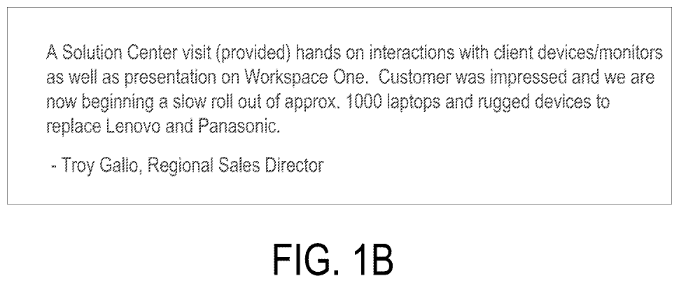

FIG. 1A is a diagram of an example of a computing system 100, according to aspects of the disclosure. The computing system 110 may include a processor 112, a memory 118, and a communications interface 126. The processor 112 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. The memory 118 may include any suitable type of volatile and/or non-volatile memory. In some implementations, the memory 118 may include one or more of a random-access memory (RAM), a dynamic random memory (DRAM), a flash memory, a hard drive (HD), a solid-state drive (SSD), a network accessible storage (NAS), and or any other suitable type of memory device. The communications interface(s) 126 may include any suitable type of communications interface, such as one or more Ethernet adapters, one or more Wi-Fi adapters (e.g., 802.1414 adapters), and one or more Long-Term Evolution (LTE) adapters, for example.

The processor 112 may be configured to execute an opportunity classifier 114 and a trainer 116. The opportunity classifier 114 may be configured to execute a machine learning model 113 for predicting whether a particular offer is going to be successful. In some implementations, the machine learning model 113 (and/or the opportunity classifier 114) may receive as input a representation of an offer and output an indication of whether the offer is likely to win the bid. In some implementations, the machine learning model 113 may classify the offer in either a “winning” class or a “losing” class. Additionally or alternatively, in some implementations, the machine learning model 113 may output a probability of the offer winning the bid. In some implementations, the machine learning model 113 may implement one or more of a neural network, a decision tree, a support vector machine, a logistic regression predictor, and/or any other machine learning model that is trained to classify an offer as either winning or losing. Additionally or alternatively, in some implementations, the machine learning model 113 may implement one or more of a neural network, a decision tree, a support vector machine, a linear regression predictor, and/or any other machine learning model that is trained to determine a probability of an offer winning the bid.

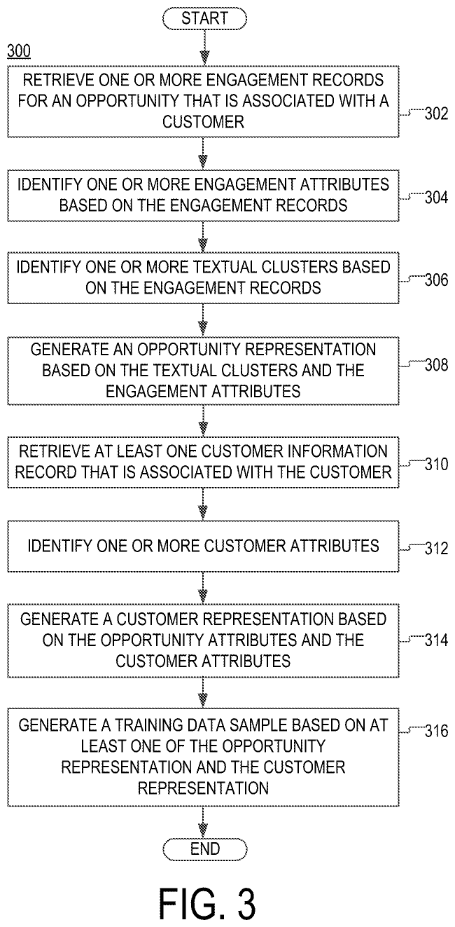

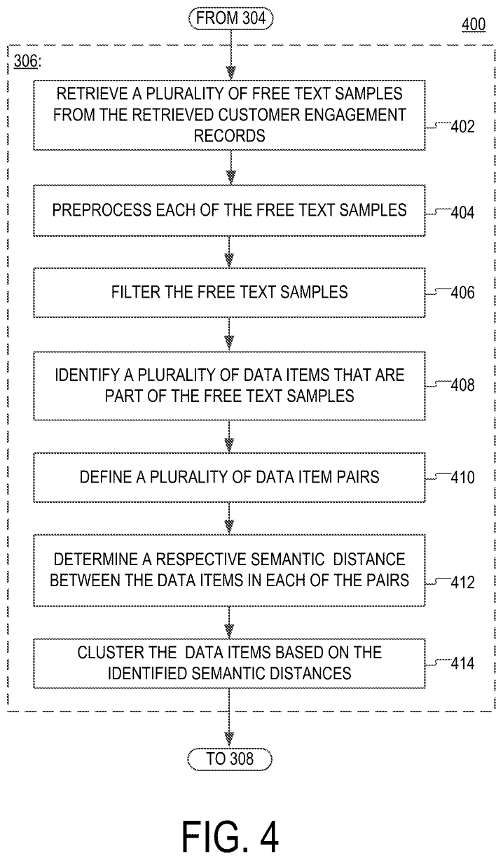

The trainer 116 may be configured to implement a supervised learning algorithm for training the machine learning model 113. Furthermore, the trainer 116 may be configured to generate training data 124 and use the training data 124 for the purpose of training the machine learning model 113 (i.e., to train the opportunity classifier 114). In some implementations, the trainer 116 may generate the training data 124 in accordance with any of the processes 300 and 400, which are discussed below with respect to FIGS. 3 and 4, respectively.

The memory 118 may be configured to store a customer engagement database 120, a customer information database 122, and the training data 124. The customer engagement database may include one or more customer engagement records 121. The customer information database 122 may include one or more customer information records 123. The training data 124 may include one or more training data samples. Each of the training data samples may be generated based on information that is found in at least one of the customer engagement database 120 and the customer information database 122. In some implementations, each training data sample may be generated in accordance with the process 300, which is discussed further below with respect to FIG. 3.

According to the example of FIG. 1A, the opportunity classifier 114 and the trainer 116 are implemented in software. However, alternative implementations are possible in which any of the opportunity classifier 114 and the trainer 116 is implemented in hardware or as a combination of hardware or software. Although in the example of FIG. 1A the opportunity classifier 114 and the trainer 116 are depicted as separate modules, it will be understood that in some implementations they can be integrated together.

According to the example of FIG. 1A, the customer engagement database 120 and the customer information database 122 are stored in the memory of the computing system 100. However, alternative implementations are possible in which at least one of the customer engagement database 120 and the customer information database 122 is located remotely. Although the customer engagement database 120 and the customer information database 122 are depicted as separate entities, alternative implementations are possible in which the customer engagement database 120 and the customer information database 122 are integrated together. Stated succinctly the present disclosure is not limited to any specific implementation of the customer engagement database 120 and/or the customer information database 122.

Although in the example of FIG. lA the computing system 100 is an integrated system, it will be understood that alternative implementations are possible in which the computing system 100 is a distributed computing system, including a plurality of computing devices. In some implementations, the trainer 116 may be executed on one computing device and the opportunity classifier 114 may be executed on another computing device. Stated succinctly the present disclosure is not limited to any specific implementation of the computing system 100.

The opportunity classifier 114, as noted above, may be used by sales representatives as a tool for determining the parameters of an offer they are planning to make to a customer. The opportunity classifier 114, as noted above, may take a representation of the offer and output an indication of whether the offer is likely to succeed (i.e., whether the offer is likely to be accepted by the customer). The opportunity classifier 114 may thus allow sales representatives to try different offer parameters, and see how these parameters portend the success of the offer. There are several advantages associated with the use of the opportunity classifier 114. In one aspect, the opportunity classifier 114 may increase the confidence of sales representatives in an offer and prevent low-balling by the sales representatives. Furthermore, the opportunity classifier 114 may prevent sales representatives from spending time on bids they have no chance of winning. Furthermore, the opportunity classifier 114 may increase the accuracy of financial revenue estimation, as it may provide a more accurate assessment of the likelihood that an active offer will be accepted by the customer.

The opportunity classifier 114, as noted above, may be trained based on data that is found in customer engagement records. According to the present disclosure, a customer engagement may include a meeting (virtual or physical) between one or more sales representatives and one or more representatives of the customer. For example, an engagement may include a technical briefing that is delivered to the customer representatives. One or more customer engagements may be associated with an opportunity to make a sale to the customer. An opportunity may be any one-time or extended interaction between a customer and representatives of the company, which is conducted for the purposes of closing a particular sale to the customer. For example, if a customer is undergoing a hardware update in which 1000 laptops are to be replaced with a newer model, the opportunity that is associated with the sale of the 1000 laptops would be associated with all customer engagements that are conducted for the purpose of (and/or are otherwise relevant to) selling the 1000 laptops.

Each (or any) customer engagement may be associated with one or more customer engagement records 121 that are stored in the customer engagement database 120. Each customer engagement record 121 may identify one or more opportunity attributes of an opportunity, which the customer engagement record is associated with. By way of example, the opportunity attributes may include one or more textual features, such as ‘Location’, ‘Visit Type’, ‘Customer Visiting Dell Site’, ‘Opportunity Type’, ‘Sales Stage at time of visit’. Additionally or alternatively, in some implementations, the opportunity attributes may include one or more numerical features such as “Total number of attendees in a meeting” and “Unweighted Rev/Forecast Amount of a sale resulting from the meeting”. Additionally or alternatively, the opportunity attributes may include one or more date or time attributes, such as ‘Opportunity create date’, ‘Opportunity start time’, ‘Customer Engagement (CE) created date’, Visit start time', and ‘Visit end time’. The dates may be used to calculate the gaps in days between the different timestamps. The gaps may measure the entire lifetime of an opportunity (e.g., the period beginning when the opportunity becomes available and ending when the opportunity is no longer available) and/or periods spanning between different stages of an opportunity (e.g., the period starting when an exploratory meeting is conducted and ending when a second technical meeting is conducted, etc.). According to the present disclosure, it has been observed that such gaps capture valuable information on the opportunity journey and they are useful in training the opportunity classifier 114. According to the present disclosure, opportunity attributes that are explicitly listed in a customer engagement record 121 are referred to as “primary opportunity attributes” and opportunity attributes that are calculated based on the primary opportunity attributes (such as the time gaps between dates) are referred to as “secondary attributes.”

Each (or any) customer engagement record 121 may additionally (or alternatively) include one or more free text samples. A free text sample may be created by any of the sales representatives. Additionally are alternative, a free text sample may be created by any of the customer representatives. A free text sample may provide high-level information about the meeting, such as ‘Engagement Objective’, ‘High Level Requirements’, ‘What else do we need to know’, ‘Engagement Technical Feedback’. Additionally or alternatively, a free text sample may include a customer survey response containing feedback from the customer regarding the engagemen. Additionally or alternatively, a free text sample may include comments (from a customer representative) on the engagement. Additionally or alternatively, a free text sample may include comments (from a sales representative) on the engagement. An example of a free text sample that is generated by a customer representative is shown in FIG. 1B. As illustrated in FIG. 1B, a free text sample may include one or more sentences and/or one or more paragraphs. A free text sample may be provided in an electronic form (e.g., a PDF-based form) or separately (e.g., as a standalone text file, etc.).

Any of the customer information records 123 may include one or more of a profile of the customer and a history of the customer's behavior. The customer profile may include one or more customer attributes, such as ‘Account Segment Business Unit’, ‘Account: Rating’, ‘Buying power’, ‘Company size’, ‘Industry’, etc. The history of the customer's behavior may include one or more customer attributes that identify characteristics of past purchases by the customer, characteristics of past opportunities with the customer, characteristics of past offers made to the customer (along with an indication of whether any of the offers were accepted). According to the present disclosure, customer attributes that are explicitly listed in a customer information record 123 are referred to as “primary customer attributes” and customer attributes that are calculated based on the primary customer attributes (such as the time gaps between dates) are referred to as “secondary customer attributes.” In some implementations, secondary customer attributes may be calculated by applying time series analysis techniques on primary customer attributes that are associated with historical opportunities and orders. Valuable secondary customer attributes include recency and ‘frequency of opportunities/orders’, ‘distribution of the type of opportunities over time’, ‘percentage of won opportunities’, etc.

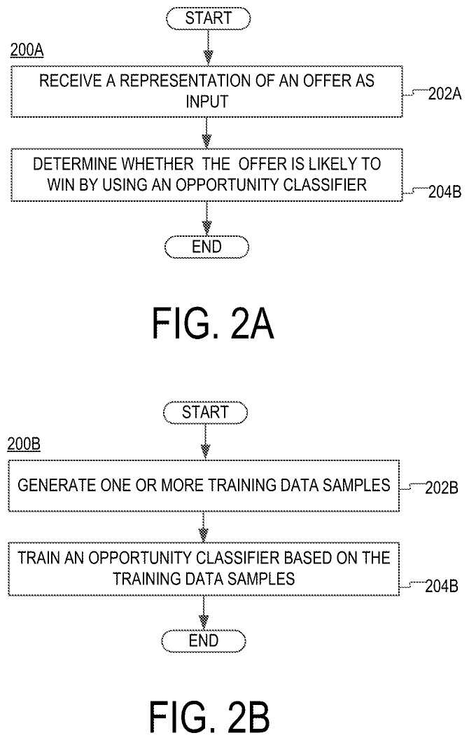

FIG. 2A is a flowchart of an example of a process 200A, according to aspects of the disclosure. At step 202A, the opportunity classifier 114 receives a representation of an offer as input. The representation of the offer may be generated in a well-known fashion, and it may be the same or similar to the opportunity representations that are known in the art. For example, in some implementations, the representation of the offer may indicate a quantity of a product that is being sold and the price of the product. Additionally or alternatively, in some implementations, the representation of the offer may be a partial representation only, and it may include fewer than all parameters of the offer. For example, a partial representation of an offer may identify only one of a product type that is being sold, a price at which the product is being sold, and a quantity that is available for sale, while the full representation of the offer may identify all three attributes. Additionally or alternatively, in some implementations, the representation of the offer may identify one or more additional events (or facts) that are associated with the offer, an account number for the customer to whom the offer is made, information about visits of the customer representatives at a customer solution center (e.g., a count of visits performed in relation the product, comments (or memos) recorded by sales representatives concerning the offer, feedback from the customer etc.. In some implementations, the representation of the offer may be the same or similar to the representation of an opportunity that is discussed further below with respect to FIG. 3, and it may be generated by using the process 300, which is discussed further below with respect to FIG. 3. The term “representation of an offer” shall refer to one or both of: (1) a representation of information concerning a current opportunity (e.g., an opportunity that is still open) for making a sale (or purchase) and (2) a representation of one or more terms of the sale, such as product, price, and quantity, for example. Additionally or alternatively, in some implementations, the representation of the offer may indicate any other suitable parameter of the offer, such as time of delivery, accepted forms of payment, etc.

At step 204A, the opportunity classifier 114 outputs an indication of how likely the offer is to succeed (or win). In some implementations, the indication may include a number or string indicating that the offer is either expected to win or expected to lose (e.g., a label of a category, which the offer has been classified in). Additionally or alternatively, in some implementations, the indication may include a number or string indicating the probability of the offer winning (or losing). Under the nomenclature of the present disclosure, an offer is said to “win” when the offer results in a purchase or sale. Similarly, the offer is said to “lose” when the offer is rejected and does not result in a purchase or sale. In the example of FIG. 2, the offer is made by the seller, however it will be understood that the opportunity classifier 114 may be used by the purchaser, as well.

FIG. 2B is a flowchart of an example of a process 200B, according to aspects of the disclosure. At step 202B, the trainer 116 generates one or more training data samples. Each of the training data samples is generated according to the process 300, which is discussed further below with respect to FIG. 3. At step 204B, the trainer 116 trains the machine learning model 113 of the opportunity classifier 114 based on the training data samples (generated at step 200B).

FIG. 3 is a flowchart of an example of a process 300 for generating a training data sample, according to aspects of the disclosure.

At step 302, the trainer 116 retrieves, from the customer engagement database 120, one or more customer engagement records 121 that are associated with a given opportunity (and/or engagement) for making a sale to a customer.

At step 304, the trainer 116 identifies one or more opportunity attributes based on the engagement records that are retrieved at step 302. In some implementations, identifying the one or more opportunity attributes may include retrieving one or more primary opportunity attributes from the engagement records. Additionally or alternatively, in some implementations, identifying one or more opportunity attributes may include calculating one or more secondary opportunity attributes based on retrieved primary opportunity attribute(s).

At step 306, the trainer 116 identifies one or more textual clusters based on the opportunity attributes. Each of the textual clusters may be identified in accordance with the process 400, which is discussed further below. According to the present example, each of the textual clusters may include a collection of textual data items (e.g., sentences) that are part of various free text samples that are included in the retrieved customer engagement records 121. The present disclosure is not limited to any specific method for representing any of the textual clusters. By way of example, in some implementations, each textual cluster may be represented as a vector of elements (e.g., numbers). Each element in the vector may correspond to a different word in a dictionary. The value of each element may indicate whether the element's corresponding word is at all part of the textual cluster and/or the frequency at which the word is found in the textual cluster.

At step 308, the trainer 116 generates an opportunity representation (e.g., a representation of a past opportunity for making a sale). The opportunity representation may include a representation of the one or more textual clusters and a representation of the opportunity attributes (identified at step 304). The representation of the opportunity attributes may include a vector of elements (e.g., numbers). Each element in the vector may correspond to a different one of a set of opportunity attributes. The value of each element may indicate the value of the element's corresponding attribute (if the corresponding attribute is among the attributes identified at step 304) and/or whether the element's corresponding attribute is at all among the attributes identified at step 304.

At step 310, the trainer 116 retrieves, from the customer information database 122, at least one customer information record 123 that corresponds to the customer that is associated with the opportunity.

At step 312, the trainer 116 identifies one or more customer attributes based on the retrieved customer information record(s). Identifying the customer attributes may include retrieving one or more primary customer attributes from the customer engagement record(s). Additionally or alternatively, identifying the customer attributes may include generating one or more secondary customer attributes based on retrieved primary attributes.

At step 314, the trainer 116 generates a customer representation based on the identified customer attributes. The customer representation may include a vector that includes a plurality of elements (e.g., numbers). Each element in the vector may correspond to a different customer attribute in a set of possible customer attributes. The value of each element may indicate the value of the element's corresponding customer attribute (if the corresponding attribute is among the customer attributes identified at step 312) and/or whether the element's corresponding attribute is at all among the customer attributes identified at step 312.

At step 316, the trainer 116 generates a training data sample based on the opportunity representation (generated at step 308) and/or the customer representation (generated at step 314). In some implementations, the training data sample may include the opportunity representation, the customer representation, and an indication of whether the opportunity representation has translated to a sale or not (e.g., a training label).

FIG. 4 is a flowchart of an example of process 400 for identifying one or more textual clusters, as specified by step 306 of the process 300.

At step 402, the trainer 116 retrieves a plurality of free text samples from the customer engagement records (retrieved at step 302). In some implementations, the trainer 116 may retrieve only free text samples that are created by sales representatives. Additionally or alternatively, in some implementations, the trainer 116 may retrieve only free text samples that are created by representatives of the customer. Additionally or alternatively, in some implementations, the trainer 116 may retrieve at least one free text sample that is generated by a sales representative and at least one free text sample that is generated by a customer representative.

At step 404, the trainer 116 preprocesses the retrieved free text samples. Preprocessing the retrieved free text samples may include one or more of applying text cleansing, applying normalization, removing stop words, and performing lemmatization.

At step 406, the trainer 116 filters the free text samples to remove words with low informational content (e.g., words that do not contribute to the entropy of the text samples). In some implementations, filtering the free text samples may include removing words such as ‘a’, ‘the,’ and ‘is’. Additionally or alternatively, in some implementations, filtering the free text samples may include removing words that appear in the free text samples more frequently than a predetermined frequency threshold. Additionally or alternatively, in some implementations, the free text samples may be filtered by using countVectorizer or another similar approach.

At step 408, the trainer identifies a plurality of data items that are part of the free text samples. According to the present example, each of the data items includes a sentence that is found in any of the free text samples. However, alternative implementations are possible in which any of the data items includes a portion of a sentence. Moreover, further alternative implementations are possible in which any of the data items includes multiple sentences, a word, and plurality of words, and/or any other suitable type of portion of a free text sample.

At step 410, the trainer 116 defines a plurality of data item pairs. In some implementations, the plurality of data item pairs may include all possible pairwise combinations between the data items (identified at step 408). As another example, the plurality of data item pairs may include only some of all possible pairwise combinations of the data items (identified at step 408).

At step 412, the trainer 116 determines the respective semantic distance (e.g., semantic similarity) between the data items in each of the pairs. In some implementations, the respective semantic distances may be determined by using Doc2Vec or another similar approach. For example, for each pair, Doc2Vec may be used to convert the data items in the pair into vectors, and then the distance between the vectors may be computed in a well-known fashion.

At step 414, the data items (identified at step 410) are clustered based on the semantic distances (identified at step 412) to produce one or more textual clusters. Each of the textual clusters may include two or more data items, such that the distance between any two data items (that are part of the textual cluster) is no greater than a threshold distance.

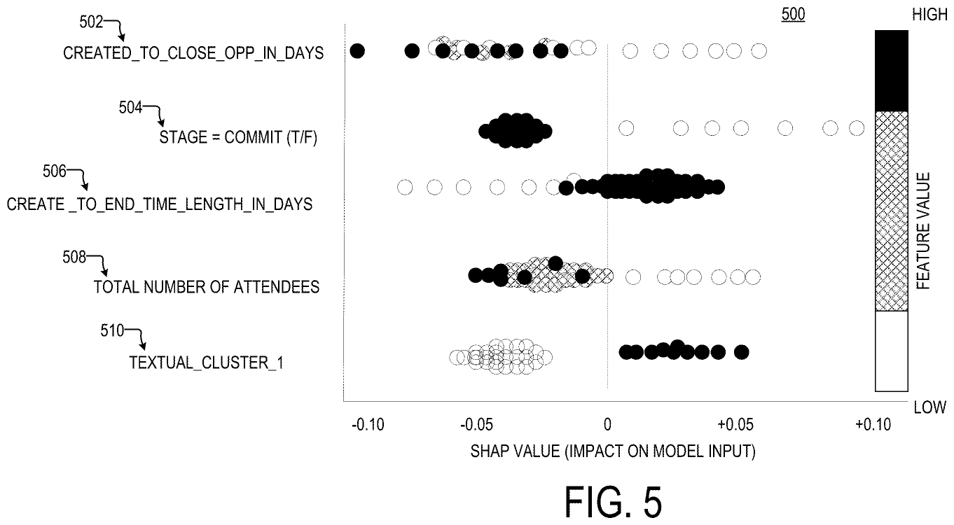

FIG. 5 is a plot 500 of the SHAP score of each of a plurality of machine learning features that are used to train the opportunity classifier 114. In the example of FIG. 5, the opportunity classifier 114 is implemented by using tree-based models, such as XGBoost, Random forest, etc, and trained accordingly. The opportunity classifier 114 is trained with training data that is generated based on training features 502-510. A training feature, according to the present example, may include a representation of an opportunity attribute, a customer attribute, or a textual cluster. The Y-axis of the plot 500 identifies each of the training features 502-510. The X-axis of the plot identifies the SHAP score that is assigned to a particular training feature value. Each circle inside the plot 500 corresponds to a training feature value. The position of each circle along the Y-axis thus identifies the type of a training feature used to train the opportunity classifier 114, the fill of each circle identifies the magnitude of a particular value of the feature, and the position of the circle along the X-axis identifies the SHAP score corresponding the particular value of the feature. Each training feature value can be part of a different training sample.

Feature 502 identifies the total lifetime (in days) of a sales attempt, from open to close. The plot 500 illustrates that opportunities with a shorter lifetime are more likely to convert to a sale. Feature 502 is (or otherwise corresponds to) a secondary (or engineered) opportunity attribute and it is generated based on primary opportunity attributes that are retrieved from the customer engagement database 120 (e.g., the respective days of engagements, etc.).

Feature 504 identifies the stage in a sales attempt at which a particular customer engagement occurred. If the engagement occurred at the commit stage, the feature is set to a first value (e.g., ‘1’). If the engagement occurred at another stage, the feature may be set to a second value (e.g., ‘0’). Although FIG. 5 shows an example of a training feature that corresponds to the commit stage, it will be understood that the opportunity classifier may be trained on other features that correspond to other stages in a sales attempt.

Feature 506 identifies an approximated lifetime of the opportunity.

Feature 508 identifies the number of attendees at a particular engagement. Feature 508 corresponds to a primary opportunity attribute. The plot 500 illustrates that engagements with a smaller number of attendees are most likely to convert to a sale.

Feature 510 is a representation of a textual cluster that is generated based on one or more engagement records. The plot 500 indicates that if an offer matches the textual cluster (i.e., feature 510) the offer may have an increased chance of winning.

It will be understood that the opportunity classifier may be trained on a much larger number of training feature than the five features that are shown in FIG. 5. FIG. 5 identifies only the top 5 most impactful features (out of all features that are used to train the opportunity classifier 114). FIG. 5 is provided to illustrate that out of the top 5 most impactful training features one is a textual cluster and the other two are secondary features (i.e., engineered features). In one respect, FIG. 5 shows that textual clusters (created according to the process of FIG. 4) constitute an excellent training feature for learning of opportunity classifiers.

Stated succinctly, in the example of FIGS. 1A-4, the opportunity classifier 114 may be trained base d on secondary attributes (e.g., secondary customer attributes and/or secondary opportunity attributes) and textual clusters. The secondary attributes represent characteristics of the historical timeline of an opportunity. And the textual clusters represent the semantic content of customer engagements that take place as part of the opportunity.

Although in the present example the opportunity classifier is trained based on textual clusters and/or secondary attributes, it will be understood that alternative implementations are possible in which the opportunity customer is trained based on only one of the secondary attributes and the textual clusters. Stated succinctly, the present disclosure is not limited to any specific method for using textual clusters (and/or secondary attributes) to train the opportunity classifier 114.

FIGS. 1A-5, are provided as an example only. At least some of the steps discussed with respect to FIGS. 1A-5 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid-state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method comprising:
retrieving one or more customer engagement records, the one or more customer engagement records being associated with an opportunity for making a sale to a customer;
identifying a plurality of free text samples that are part of the customer engagement records;
identifying a plurality of data items that are part of the free text samples;
calculating a plurality of semantic distances, each of the semantic distances corresponding to a different one of a plurality of data item pairs;
clustering the data items into textual clusters based on the identified semantic distances; and
training a classifier based, at least in part, on the textual clusters, the classifier being configured to receive an offer for the customer, classify the offer and output an estimation of whether the offer is expected to result in a sale.

2. The method claim of claim 1, wherein at least one of the free text samples includes one of: (i) a natural language note summarizing one or more events that transpired during a particular customer engagement or (ii) a natural language note providing feedback from the customer regarding a particular customer engagement.

3. The method of claim 1, wherein each of the data items includes a sentence.

4. The method of claim 1, wherein calculating a semantic distance that is associated with a data item in a pair includes:
generating a first vector that represents a first data item in the data item pair;
generating a second vector that represents a second data item in the data item pair;
calculating a distance between the first vector and the second vector.

5. The method of claim 1, further comprising identifying an attribute of a historical timeline of the opportunity, wherein the attribute is identified by using the one or more engagement records, and the opportunity classifier is trained further based on the attribute.

6. The method of claim 1, further comprising identifying a lifetime of the opportunity based on the one or more engagement records, wherein the opportunity classifier is trained further based on the lifetime of the opportunity.

7. The method of claim 1, wherein the classifier is configured to classify the offer as either: (i) an offer that is expected to result in a sale or (ii) an offer that is not expected to result in a sale.

8. A system comprising:
a memory; and
at least one processor that is operatively coupled to the memory, the at least one processor being configured to perform the operations of:
retrieving one or more customer engagement records, the one or more customer engagement records being associated with an opportunity for making a sale to a customer;
identifying a plurality of free text samples that are part of the customer engagement records;
identifying a plurality of data items that are part of the free text samples;
calculating a plurality of semantic distances, each of the semantic distances corresponding to a different one of a plurality of data item pairs;
clustering the data items into textual clusters based on the identified semantic distances; and
training a classifier based, at least in part, on the textual clusters, the classifier being configured to receive an offer for the customer, classify the offer and output an estimation of whether the offer is expected to result in a sale.

9. The system of claim 8, wherein at least one of the free text samples includes one of: (i) a natural language note summarizing one or more events that transpired during a particular customer engagement or (ii) a natural language note providing feedback from the customer regarding a particular customer engagement.

10. The system of claim 8, wherein each of the data items includes a sentence.

11. The system of claim 8, wherein calculating a semantic distance that is associated with a data item in a pair includes:
generating a first vector that represents a first data item in the data item pair;
generating a second vector that represents a second data item in the data item pair;
calculating a distance between the first vector and the second vector.

12. The system of claim 8, wherein:
the at least one processor is further configured to perform the operation of identifying an attribute of a historical timeline of the opportunity, and
the attribute is identified by using the one or more engagement records, and the opportunity classifier is trained further based on the attribute.

13. The system of claim 8, wherein:
the at least one processor is further configured to perform the operation of identifying a lifetime of the opportunity based on the one or more engagement records, and
the opportunity classifier is trained further based on the lifetime of the opportunity.

14. The system of claim 8, wherein the classifier is configured to classify the offer as either: (i) an offer that is expected to result in a sale or (ii) an offer that is not expected to result in a sale.

15. A non-transitory computer-readable storage medium that is configured to store one or more processor executable instructions, which, when executed by one or more processors, cause the one or more processors to perform the operations of:
retrieving one or more customer engagement records, the one or more customer engagement records being associated with an opportunity for making a sale to a customer;
identifying a plurality of free text samples that are part of the customer engagement records;
identifying a plurality of data items that are part of the free text samples;
calculating a plurality of semantic distances, each of the semantic distances corresponding to a different one of a plurality of data item pairs;
clustering the data items into textual clusters based on the identified semantic distances; and
training a classifier based, at least in part, on the textual clusters, the classifier being configured to receive an offer for the customer, classify the offer and output an estimation of whether the offer is expected to result in a sale.

16. The non-transitory computer-readable storage medium of claim 15, wherein at least one of the free text samples includes one of: (i) a natural language note summarizing one or more events that transpired during a particular customer engagement or (ii) a natural language note providing feedback from the customer regarding a particular customer engagement.

17. The non-transitory computer-readable storage medium of claim 15, wherein each of the data items includes a sentence.

18. The non-transitory computer-readable storage medium of claim 15, wherein calculating a semantic distance that is associated with a data item in a pair includes:
generating a first vector that represents a first data item in the data item pair;
generating a second vector that represents a second data item in the data item pair;
calculating a distance between the first vector and the second vector.

19. The non-transitory computer-readable storage medium of claim 15, wherein:
the one or more processor-executable instructions, when executed by the one or more processors, further cause the one or more processors to perform the operation of identifying an attribute of a historical timeline of the opportunity, and
the attribute is identified by using the one or more engagement records, and the opportunity classifier is trained further based on the attribute.

20. The non-transitory computer-readable storage medium of claim 15, wherein:
the one or more processor-executable instructions, when executed by the one or more processors, further cause the one or more processors to perform the operation of identifying a lifetime of the opportunity based on the one or more engagement records, and
the opportunity classifier is trained further based on the lifetime of the opportunity.
